(19) United States
(12) Patent Application Publication
(10) Pub. No.: US 2007/0289224 A1
(43) Pub. Date: Dec. 20, 2007

(54) Composite coating for architectural pieces

(76) Inventor: Ronald L. Parmley, Lake St. Louis, MO (US)

Correspondence Address: POLSTER, LIEDER, WOODRUFF & LUCCHESI, 12412 POWERSCOURT DRIVE SUITE 200, ST. LOUIS, MO, 63131-3615, US

(21) Appl. No.: 11/726,475

(22) Filed: Mar. 22, 2007

Related U.S. Application Data
(63) Continuation-in-part of application No. 11/471,131, filed on Jun. 20, 2006.

(51) Int. Cl. B28D 1/00

(52) U.S. Cl. 52/21; 52/309.1; 52/379; 52/514.5

(57) ABSTRACT

The present invention relates to a composite coating for architectural pieces used in building and remodeling of existing buildings. The architectural pieces include plastics, polyurethanes, wood and glass decorative items, granite and all manners of stone, wood inlays, wood flooring products, full size brick and pavers as well as thin veneer varieties such as brick or stone veneer. In addition, the invention relates to a method for grouting the architectural pieces.

### CROSS-REFERENCE TO RELATED APPLICATIONS

This application is a continuation-in-part of application U.S. Ser. No. 11/471,131 filed Jun. 20, 2006.

### STATEMENT REGARDING FEDERALLY SPONSORED RESEARCH

Not Applicable

### BACKGROUND OF THE INVENTION

The present invention relates to a composite coating for architectural pieces used in building and remodeling of existing buildings. The architectural pieces include plastics, polyurethanes, wood and glass decorative items, granite and all manners of stone, wood inlays, wood flooring products, full size brick and pavers as well as thin veneer varieties such as brick or stone veneer. In addition, the invention relates to a method for grouting the architectural pieces.

In the conventional practice of performing grouting work, one sees the bricklayer on his knees placing each brick on the surface to be covered, while extruding grout from a funnel shaped, hand-held supply of grout. He then smoothes the grout by hand between the brick or stone, allows the grout to cure, and subsequently washes and polishes the brick or stone to remove any excess grout before applying a finishing coating.

The laying of brick or stone veneer whether it be on a wall, a driveway or a patio, is a highly skilled occupation, commanding high wages. The level of skill required, and the time-consuming nature of conventional brick or stone veneer installation render the process very expensive. As a result, the use of brick or stone veneer occurs only in those areas where it is nearly indispensable, e.g., fireplace surrounds or decorative exterior wall fronts. Because the industry of laying architectural pieces, such as brick or stone veneer, is so labor intensive, shortcuts have been considered but heretofore have not been found to be effective.

U.S. Pat. No. 1,994,644 to N. P. Harshberger provides a method of laying tiles or blocks wherein the binding material may be so formed as to cause it to be either flush with the surface of the blocks, in the form of grooves, or in the form of ridges. A covering over the surface of the blocks is used to control the level of the binding material to establish whether grooves or ridges are formed between the blocks.

U.S. Pat. No. 5,740,653 to Leonid Dubizhansky makes the grouting of tile somewhat easier. The patent sets forth a process wherein the tiles are covered with a self-adhesive, impenetrable, flexible, sheeting material applied to the top surface and the peripheral sides of the tile before grouting. The protective sheeting material eliminates contact between the grout and the tile surface as well as the sides of the tile, thereby eliminating the need for pre-grouting sealer application, tile washing, tile cleaning or acid cleaning of the tile after grouting. Although this method protects the tile face, the protective sheeting also covers at least part of the peripheral sides of the tile. After grouting, when the protective sheeting is removed from the peripheral sides of the tile, the grout pulls away from the sides of the tile and a space is left between the grout and the tile which has to be filled by hand with additional grout in order to provide a suitable grout joint. When applying the additional grout, the grout tends to get on the tile surface thereby requiring cleaning of the tile surface.

Although the grouting of tile is somewhat similar to that of brick or stone veneer, the tile has a slick surface and therefore is easier to clean after grouting.

### BRIEF SUMMARY OF THE INVENTION

The present invention relates to a composite coating for architectural pieces used in building and remodeling of existing buildings. The architectural pieces include plastics, polyurethanes, wood and glass decorative items, granite and all manners of stone, wood inlays, wood flooring products, full size brick and pavers as well as thin veneer varieties such as brick or stone veneer. In addition, the invention relates to a method for setting the coated architectural pieces in grout or other adhesive material.

The composite coating comprises major portions of a thermoplastic resin and a plasticizer and minor portions of a stabilizer and a release agent, all in such proportions that the resulting mixture when mixed and melted and applied to the upper surface of the architectural piece and cooled provides a coating covering the upper surface of the architectural piece. The composite coating has a softening point above about 170° F., a low friction surface, is waterproof, has a low tack and is peelable from the architectural piece using from about 1 to about 4 psi of pull.

The composite coating adheres to the upper surface of the architectural piece while filling any pores or pits in the surface. The composite coating cures at room temperature to form an architectural piece with a slick, low friction coating which allows the handling, shipping and laying of the piece in a desired pattern for the application of grout or other adhering material.

The grouting process is easily achieved by applying grout over a selected pattern of the coated pieces using a suitable tool, e.g., a squeegee or the like. After the grout is dried or cured, the composite coating is easily peeled from each architectural piece using as little as about one pound per square inch of force to remove the composite coating. The composite coating simply peels off the architectural piece. No residue from the composite coating remains on the piece. The pieces securely grouted or adhered in the desired pattern are clean and dry and ready for application of any desired finishing compound.

The coating composition is ultraviolet resistant so that when the coated pieces are stored outdoors prior to use, the sun does not substantially alter the composite coating as to color or texture.

The composite coating provides a low friction surface on the coated piece. For example, when laying a brick veneer patio, a layer of thin set adhesive (a term of the art for an adhesive base on to which the veneer pieces are placed in position before grouting) is applied to the surface on to which the veneer pieces are placed in the desired pattern. Preferably, the veneer pieces are worked into the thin set adhesive so the pattern holds its intended position. The grout is then applied to the entire surface without regard to each of the veneer piece surfaces. Application of the grout may be accomplished standing up using a squeegee or like tool. After the grout is cured, the composite coating is simply removed from each veneer piece by a simple peeling procedure.

Generally, when the pieces are for a patio or driveway, a concrete surface is laid before the pieces are laid. The concrete surface needs to be completely cured and accepting of water penetration to provide the preferred bond to any adhesive used and to the coated pieces laid by the process of the present invention.

The coated pieces are particularly suitable for a patio, walkway or driveway surface. However, they may also be used for interior halls or flooring in homes or commercial buildings.

In addition, the present invention applies to walls of buildings both exterior and interior, surrounding fire places or hearths, or the exterior surfacing of a home or building. In one embodiment, it may be advantageous to attach the bottom surface of the coated pieces to a mesh like material or other substance in a desired pattern. The coated pieces attached to the mesh can be handled or shipped to the place of construction and simply laid out on the surface to which the coated pieces are to be attached. The grout is then applied without regard to the surface of the coated pieces. After curing of the grout, the composite coating on the pieces is removed by peeling the coating. The composite coating material removed by peeling can be recycled by blending it with another batch of the composite coating material.

A new method for creating a brick or stone veneer wall using the coated veneer pieces starts with a preformed liner having a pattern for bricks embossed into the liner. The interior of the liner is sprayed with an adhesive and the coated bricks are laid into the embossed indentations with the coated side of the brick impacting the adhesive. The liner is lying at the base of a form for forming a concrete wall. Concrete is poured generally up to about six inches in thickness, on top of the liner containing the coated bricks. After the concrete has dried and is cured, the concrete wall is put in place. The brick side of the wall still has the liner attached to it. When the liner is removed, the pieces of the composite coating are also removed with the liner. The brick wall is finished and requires no washing or cleaning.

Conventionally when brick veneer walls of this type are poured, water leaches in between the liner and the brick and stains the brick exterior so that following the removal of the liner, it is necessary to power wash the wall. When utilizing the coated brick veneer pieces of the present invention, the water from the concrete does not get between the coating and the brick so the brick comes out clean when the liner is removed.

The advantages of the present invention are numerous. The arduous task of grouting brick or stone or other architectural pieces piece by piece is eliminated. Each coated piece is completely clean after removal of the composite coating thereby eliminating a messy cleaning process following grouting of brick or stone surfaces. Conventionally, a finish coating is applied to the installed pieces and grout. Such architectural pieces provide a surface which requires substantially no care for a long period of time whether it be a driveway, a wall or a walkway surface.

### BRIEF DESCRIPTION OF THE SEVERAL VIEWS OF THE DRAWINGS

The objects of the invention are achieved as set forth in the illustrative embodiments shown in the drawings which form a part of the specification.

FIG. 1 is a perspective view of one method of applying the composite coating to veneer pieces in one embodiment of the present invention;

FIG. 2 is a perspective view of a subsequent step to FIG. 1 of the method of the present invention;

FIG. 3 is a perspective view of another step of the method of the present invention; and

FIG. 4 is a perspective view of a further step of the method of the present invention.

Corresponding reference characters indicate corresponding parts throughout the several views of the drawings.

### DETAILED DESCRIPTION OF THE INVENTION

The following detailed description illustrates the invention by way of example and not by way of limitation. This description will clearly enable one skilled in the art to make and use the invention, and describes several embodiments, adaptations, variations, alternatives and uses of the invention, including what I presently believe is the best mode of carrying out the invention. As various changes could be made in the above constructions without departing from the scope of the invention, it is intended that all matter contained in the above description or shown in the accompanying drawings shall be interpreted as illustrative and not in a limiting sense.

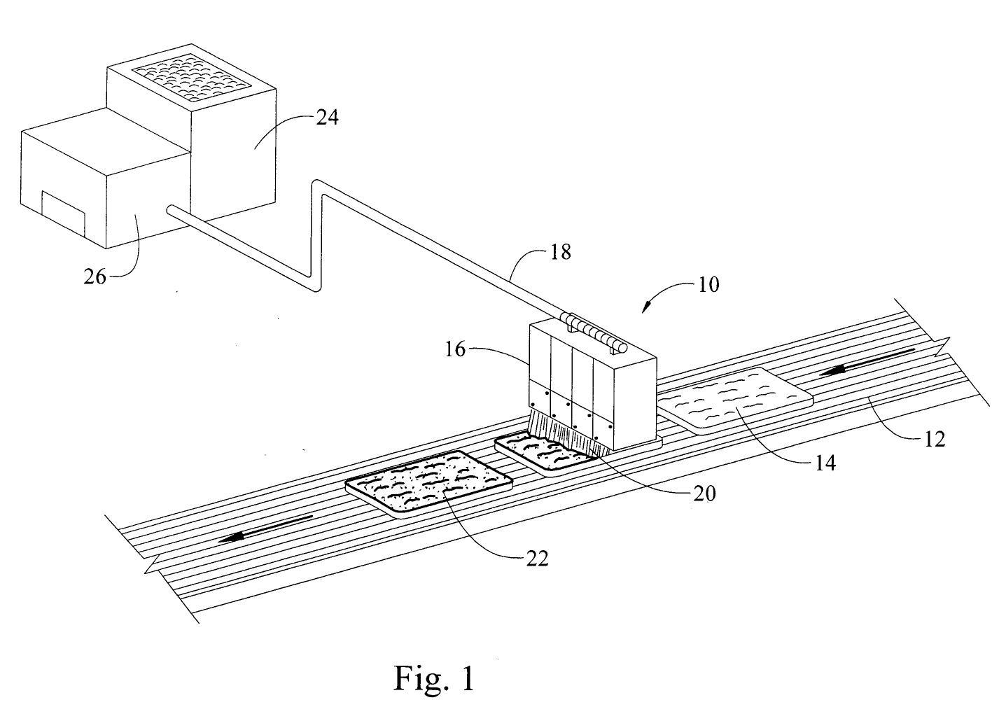

FIG. 1 is a perspective view of step one of a method for one embodiment of the present invention. A spray applicator 10 is mounted above a conveyor 12. The conveyor 12 moves a veneer piece 14 (in this embodiment the architectural piece is a brick veneer) beneath a sprayer 16 which sprays the composite coating 20 on to the brick 14 passing beneath the sprayer 16. A coated brick 22 continues on the conveyor where it is cooled until the coating becomes solid and the brick 22 can be stored until time for its use. The coating composition is formed in the mixer 24 and passed through a heating station 26 where the coating composition is a free-flowing liquid. The liquid is then conveyed through an insulated feeder pipe 18 to the sprayer 16 above the conveyor 12. The sprayer 16 is metered so as to spray only on the brick 22 as it passes beneath the sprayer 16.

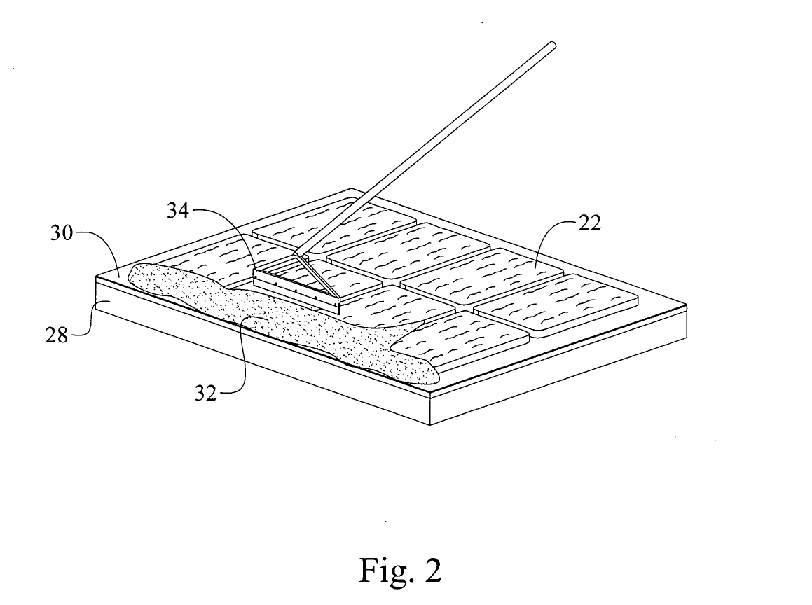

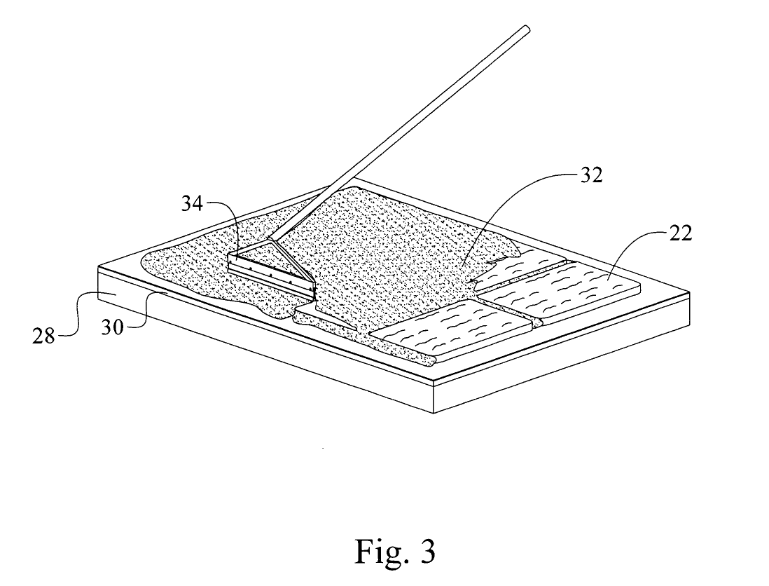

FIGS. 2 and 3 illustrate the ease with which grout 32 can be applied to a pattern of the coated bricks 22. Conventionally when laying a pattern of bricks 22 a base 28 is provided. The base 28 may be poured concrete, a wood floor or other suitable substrate. A layer of adhesive 30 is applied to the substrate 28 prior to laying the bricks 22 in their desired pattern. A suggested adhesive product is MegaLite Crack Prevention Mortar sold by Custom Building Products, Seal Beach, Calif. Products of this nature are identified in the industry as “thin-set” adhesive. The thin-set adhesive 30 is applied by use of a rake trowel to the surface 28 to be covered with the bricks 22. Grout 32 is applied without regard for the coated surfaces of the bricks 22. The grout 32 is simply applied over the entire surface of bricks 22 with a suitable applicator 34. As shown in FIG. 3 the surface of the bricks 22 may be substantially covered with grout 32 so as to fill all of the spaces between the bricks 22 with grout 32. The grout 32 on the surfaces of the bricks 22 is then swept away with a squeegee or other appropriate tool.

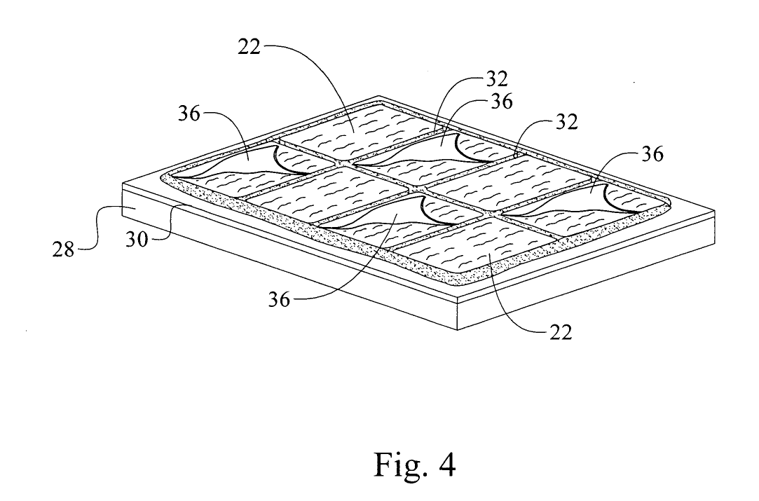

FIG. 4 illustrates the final step in the procedure of applying grout 32 to a pattern of coated bricks 22. The coating 36 on each brick 22 is simply peeled from the brick 22 after the grout 32 has been cured. The surface of each brick 22 is clean and dry and ready for any finishing coating and the like. The peeled coating pieces 36 can be recycled to the mixing bin 24 of FIG. 1.

Advantages of the present invention are many. The coated pieces, after the coating has cooled and stabilized, can be packaged and shipped just as conventional architectural pieces are shipped. Since the coating of the architectural pieces is UV resistant, the coated pieces can be stored outside without damage to the coating or the pieces. The presence of the coating also helps to prevent chipping of the architectural pieces when shipping and handling.

Highly skilled labor is not required to build a patio or driveway surface or side to a building of architectural pieces resulting in a functioning and appealing finished product. In fact, the grout can be applied to the entire surface (FIG. 3) and then the excess grout is easily wiped away (FIG. 4) after which the grout 32 is cured and then the pieces of coating 36 are removed. A conventional sealant can then be applied, if desired.

### EXAMPLE 1

In a typical example of the present invention, the following constituents are mixed in a mixer 24:

| | Parts by weight |
|---|---|
| Cellulose acetate butyrate | 55 |
| Dioctyl terephthalate (or triethyl citrate) | 47 |
| Epoxidized soy bean oil | 2 |
| Di-n-octyl tin bis isooctyl maleate | 1 |
| Butyl stearate | 0.5 |

The mixed ingredients are heated in a heater 26 to about 350° F. whereupon the mixture is liquid and is pumped through an insulated pipe 18 to a spray applicator 16 as depicted in FIG. 1. The spray applicator 16 provides hot air to maintain the temperature of the liquid being sprayed at approximately 350° F. The spray applicator 16 is programmed to spray substantially only the surface of the brick veneer piece 14 as the brick 14 passes beneath the spray 20. The coated bricks 22 are conveyed by the conveyor 12 to a cooling area (not shown). Once the coated bricks 22 have cooled to room temperature, they are ready for shipping and use.

The coating 36 (FIG. 4) generally has a thickness from about 1 mm to about 20 mm and is adhered to the surface of the brick veneer 22 with a tack requiring a pull force of about 1 to about 4 psi to remove the coating 36 from the brick veneer piece 22. The surface of the coating 36 has a very low friction coefficient which allows the grout to pass over the coating into the spaces between the veneer pieces 22 when applying the grout.

Once the coated bricks 22 are laid and grout applied as shown in FIGS. 2, 3 and 4, and the grout has cured, the coating 36 on the bricks 22 can be removed by simply peeling the coating 36 from the brick veneer pieces 22.

### EXAMPLE 2

In another example of the present invention, the following constituents are mixed in a mixer 24:

| | Parts by weight |
|---|---|
| Cellulose acetate butyrate | 50 |
| Diisodecyl phthalate | 50 |
| Triethylene glycol | 2 |
| Diisophenyl phosphite | 2 |
| Wax | 2 |
| Ditertiary butyl methyl propylene | 2 |
| Dithioerythritol | 2 |

The mixed ingredients are heated in a heater 26 to about 350° F., and applied in a manner similar to Example 1.

The above examples of a coating composition of the present invention are merely exemplary. Example 1 is the preferred embodiment at this time, but modifications of the formulation are included herein. For instance, there are several thermoplastic resins which will work in the formulation of the composite coating. These are known to those skilled in the art. The same is true for the plasticizer, the stabilizer and the release agent.

The coating components are generally in bulk form, e. g., in pellets, granules, small pieces or liquid. This bulk form allows mixing to take place uniformly resulting in a substantially uniform melt when heated to a temperature of about 350° F. The melt, in a fluid state, permits pumping of the fluid to a sprayer for application to the architectural pieces or such application may be effected with a spray gun, a roller, a brush or the like. The composite coating in its melted state has pore filling characteristics assisting in the adherence of the coating to the substrate whether the architectural piece is tile or brick or stone or wood or glass or the like.

The composite coating upon cooling quickly forms a relatively hard, but flexible outer shell. The surface of the composite coating has low friction properties which prevents the coated pieces from sticking to each other. Furthermore, when the grout or other adhering material is applied, the low friction surface allows the grout to slide off of the coating thus leaving the grout in between the coated pieces. Quite simply, after the pieces are laid in the desired pattern, the grout is “slopped on” the entire surface area and then worked in between the veneer pieces by use of a squeegee tool making sure that all voids between the coated pieces are filled. The grout is allowed to cure and then the composite coating is peeled from each architectural piece leaving substantially no residue and the architectural pieces are ready for any finishing treatment desired.

The composite coating provides a protective shell for the architectural pieces during shipping and handling. The protective shell prevents the coated pieces from sticking together. Furthermore, the adherence of the protective shell prevents grout or moisture from seeping under the coating when the coated pieces are stored or in the process of grouting. The composite coating is ultra violet resistant preventing damage from occurring when the coated pieces are stored outside in the weather. The composite coating has a softening temperature of at least 170° F. so that the coating remains in its relatively hard shell condition when the coated pieces are stored outside.

The composite coating has sufficient clarity to see through the coating to permit visual inspection of the product and the product color.

The composite coating adheres to any and all surfaces. For example, sanded brick has become very popular as the exterior of a wall. When uncoated sanded bricks are placed in a liner as discussed above, the water from the concrete poured to form the wall stains the sanded brick while the concrete wall is curing. The brick then has to be power washed, but power washing tends to destroy a significant amount of the sand on the brick. When the composite coating of the present invention is utilized, the concrete water does not seep onto the sanded brick surface but the composite adheres to the brick surface until the coating is peeled from the surface of the sanded brick.

In view of the above, it will be seen that the several objects and advantages of the present invention have been achieved and other advantageous results have been obtained.

Having thus described the invention, what is claimed and desired to be secured by Letters Patent is:

1. A composite coating suitable for coating the upper surface of an architectural piece, which comprises major portions of a thermoplastic resin and a plasticizer and minor portions of a stabilizer and a release agent in such proportions that the resulting mixture when mixed and melted and applied to the upper surface of an architectural piece and cooled provides a coating which has a softening point above about 170° F., a low friction surface, is waterproof, has a low tack and is peelable from the architectural piece using from about 1 to about 4 psi of pull.

2. The composite coating of claim 1 wherein the thermoplastic resin is cellulose acetate butyrate.

3. The composite coating of claim 1 wherein the plasticizer is dioctyl terephthalate

4. The composite coating of claim 1 wherein the stabilizer is di-n-octyl tin bis isooctyl maleate.

5. The composite coating of claim 1 wherein the release agent is butyl stearate.

6. An architectural piece having a composite coating on the upper surface of the architectural piece, the coating comprising major portions of a thermoplastic resin and a plasticizer and minor portions of a stabilizer and a release agent in such proportions that the resulting mixture when mixed and melted and applied to the upper surface of the architectural piece and cooled provides a coating which has a softening point above about 170° F., a low friction surface, is waterproof, has a low tack and is peelable from the architectural piece using from about 1 to about 4 psi of pull.

7. The coated architectural piece of claim 6 wherein the architectural piece is selected from the group consisting of stone, slate, travestine, wood, glass, porcelain, plastics, polyurethanes, granite, wood inlays, wood flooring products, full size brick, full size pavers, brick veneer and stone veneer.

8. The coated architectural piece of claim 6 wherein the thermoplastic resin is cellulose acetate butyrate.

9. The coated architectural piece of claim 6 wherein the plasticizer is dioctyl terephthalate or triethyl citrate.

10. The coated architectural piece of claim 6 wherein the stabilizer is di-n-octyl tin bis isooctyl maleate.

11. The coated architectural piece of claim 6 wherein the release agent is butyl stearate.

12. A method for grouting coated architectural pieces which comprises:
a. fixing the architectural pieces in a predetermined pattern,
b. applying grout or an adhering material over the coated pieces without regard for the coated pieces,
c. allowing the grout or adhering material to cure, and
d. removing the composite coating from the architectural pieces.

13. A method for making a concrete wall having brick or stone veneer pieces which comprises:
a. providing an embossed liner having a desired pattern to hold the veneer pieces in place in the base of a concrete wall form;
b. spraying an adhesive onto the embossed liner;
c. placing composite coated veneer pieces onto the liner with the composite coated side of the veneer pieces contacting the adhesive on the liner;
d. pouring concrete into the concrete wall form;
e. allowing the concrete to cure forming a concrete wall;
f. removing the form from the concrete wall; and
g. removing the liner along with the coating from the veneer pieces resulting in a concrete wall containing veneer pieces.

14. A concrete wall prepared by the method of claim 13 wherein the composite coated veneer pieces are sanded brick veneer pieces.
